(19) United States
(12) Patent Application Publication
(10) Pub. No.: US 2012/0026273 A1
(43) Pub. Date: Feb. 2, 2012

(54) FOCUSING A LASER ON A LABEL SURFACE OF AN OPTICAL DISC

(76) Inventors: Timothy Wagner, Corvallis, OR (US); Donald B. Ouchida, Corvallis, OR (US)

(21) Appl. No.: 13/260,374

(22) PCT Filed: Apr. 15, 2009
(86) PCT No.: PCT/US2009/040643

§ 371 Date: Sep. 25, 2011

(51) Int. Cl. B41J 2/435

(52) U.S. Cl. 347/247

(57) ABSTRACT

A method, apparatus, and medium for determining actuator signals for focusing a laser on a label surface of an optical disc. A plurality of virtual angular sectors are defined on the label surface. A single rotation of the disc is performed. During the rotation, the focus of the laser is sinusoidally swept from a baseline once per sector. During the rotation, a SUM signal indicative of a degree of focus of the laser on the label surface is measured at a plurality of angular positions of each sector. The actuator signals are derived from the measured SUM signals.

### BACKGROUND

Some optical disc drives are capable of generating a visible label on an optical disc removably inserted in the disc drive. Optical discs for use with such drives typically have, in addition to a mechanism which allows digital data to be stored on the disc, an internal or external labeling surface that includes a material whose color, darkness, or both can be changed, with the controlled application of a laser beam thereto, in order to form visible markings at the positions on the labeling surface at which the laser beam is applied. The visible markings that constitute the label can collectively form text, graphics, and photographic images on the optical disc. Such a labeling mechanism advantageously avoids the need for additional equipment such as a silk-screener, or for the inconvenience of having to print and attach a physical label to the disc. Many users would also like the visible markings to form a label of high image quality and be produced as quickly as possible.

### BRIEF DESCRIPTION OF THE DRAWINGS

The features of the present invention and the manner of attaining them, and the invention itself, will be best understood by reference to the following detailed description of embodiments of the invention, taken in conjunction with the accompanying drawings.

FIG. 1 is a schematic representation of an optical disc in accordance with an embodiment of the present invention that illustrates features of a label surface.

FIG. 2 is a schematic representation of an optical disc drive in accordance with an embodiment of the present invention for marking the label surface of the optical disc of FIG. 1.

FIG. 3 is a schematic representation of the sweeping of laser focus optics in accordance with an embodiment of the present invention from a baseline position according to a sine wave in one revolution of the optical disc of FIG. 1.

FIGS. 4A and 4B are a flowchart in accordance with an embodiment of the present invention of a method of forming a visible label on the optical disc of FIG. 1, including determining actuator signals for focusing a laser on the label surface of the optical disc of FIG. 1.

### DETAILED DESCRIPTION

Referring now to the drawings, there are illustrated embodiments of the present invention that determine focus actuator signals for a laser mechanism of an optical disc drive that can be used to form a visible label of a high image quality on an optical disc inserted in the disc drive. The label is formed by the properly-focused laser controllably making visible marks on a label surface of the optical disc, in accordance with label data received by the disc drive.

To achieve a high level of image quality, the size, color, and/or darkness of the spots or marks formed by the laser on the optical disc should be consistent. The characteristics of these spots are determined at least in part by the degree of focus of the laser beam, generated by the laser mechanism, on the virtual track on which the marks are being formed. The optical drive has a focus actuator that positions laser focus optics at a z-axis position above the virtual track on the label surface in response to the focus actuator signals. The z-axis position of the laser focus optics determines the degree of focus of the laser beam on the virtual track, at least in part. During labeling, the focus actuator is operated to place the laser's focus optics at the desired z-axis position relative to the label surface.

However, an optical disc may not be perfectly flat. Instead, it may be warped in some manner. Furthermore, the disc may be tilted when it is inserted into the disc drive. As a result, to achieve high quality imaging under such conditions, the z-axis position at which the laser focus optics are positioned by the focus actuator to maintain the desired distance relative to the label surface can vary with both the radial position of a virtual track from the hub of the optical disc, and with the angular position around a virtual track, according to a “surface contour” of the optical disc in the disc drive that results from the warp and the tilt. In order to determine the appropriate actuator signals to apply to the focus actuator at the various radial and angular positions to be labeled on the optical disc, the surface contour of the disc, as it is installed in the disc drive, can be “mapped”, or characterized, before the laser forms the marks. The mapping results may then be used to construct a surface model usable to generate the proper focus actuator signals to focus the laser when the laser marks the various radial and angular positions on the optical disc in a subsequent marking operation.

The time to map the surface contour adds to the total amount of time it takes to label the disc. Thus it is advantageous to perform this operation in as short a time as possible. In addition, some multiple-layer optical discs, such as DVDs, can exhibit a warp with higher frequency surface deviations than optical discs of a simpler structure. Thus it is advantageous to construct a surface model that better models these higher frequency surface deviations.

As will be described in greater detail subsequently, embodiments of the present invention advantageously reduce the time it takes to map the surface contour, and thus reduce the total time it takes to label the disc. Mapping angular sectors of the surface using a sinusoidal sweep or perturbation of the laser focus optics from a baseline position allows the mapping for a given radial position to be completed in a single revolution of the disk. Sinusoidally sweeping the focus optics reduces overshoot and ringing in their positioning, which in turn allows the number of angular sectors defined on the optical disc to be increased, the disc to be rotated faster, or both. An increased number of angular sectors allows construction of a surface model that better models higher frequency surface deviations.

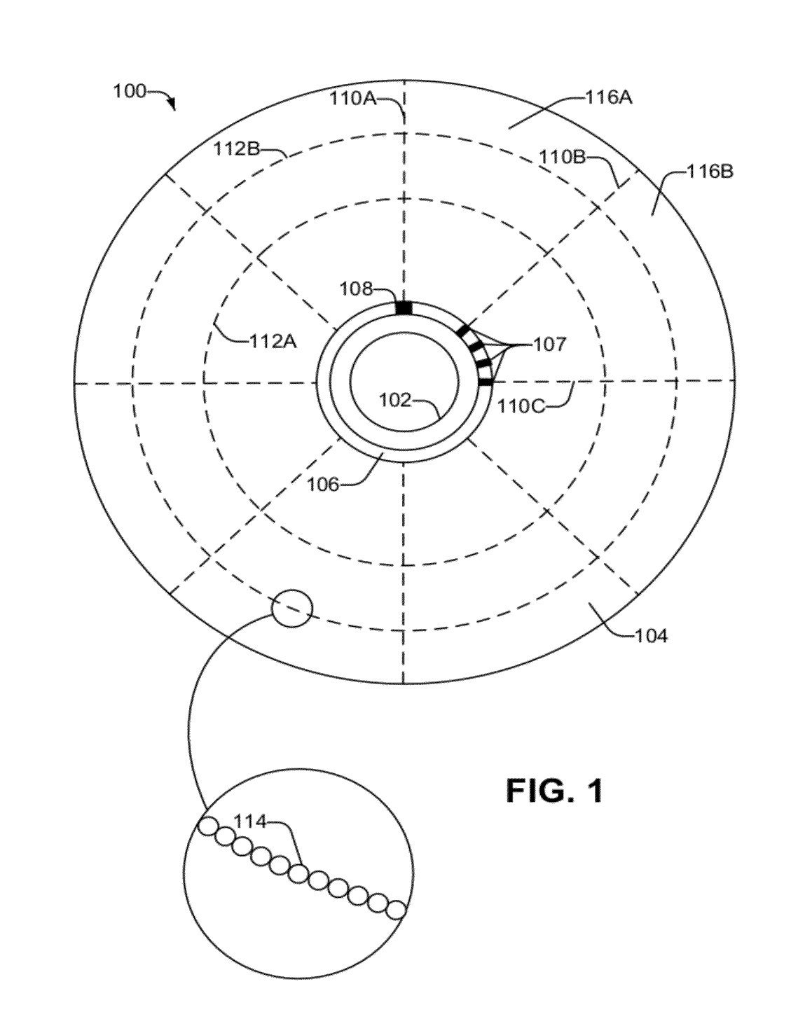

Considering now one embodiment of an optical disc, and with reference to FIG. 1, the optical disc 100 may be a CD (compact disc), DVD (digital versatile disc), or other forms of optical discs capable of forming visible markings on or within the disc in response to the application of electromagnetic energy, such as from a laser, to the disc. This includes discs in CD-R, CD-RW, DVD+R, DVD-R, DVD+RW, DVD-RW, DVD-ROM, and Blu-ray formats, and the like. Such discs also typically store digital data that may represent, for example, photographs, videos, music, computer programs, and other various types of information or data. In some discs the data is prefabricated, while in other discs the data may be written to the disc using an optical disc drive. Digital data stored on a disc can be read from the disc using an optical disc drive.

Various physical and chemical structures may be used to provide the optical disc with the capability of forming the visible markings in response to the application of a proper amount of electromagnetic energy to the disc. In one embodiment, a labeling layer or coating is applied to at least a portion of a surface of the disc. In one embodiment, the layer is applied to the disc surface on the opposite side of the disc from the surface through which laser energy is impinged to read or write the digital data. In one embodiment, the labeling coating is a laser-sensitive layer that has thermochromic and/or photochromic materials that can be activated at desired locations by the application of laser energy to the desired locations. In some embodiments the materials may be sensitive only to energy within a particular band of frequencies, either visible or invisible. In one embodiment, these frequencies may be in the infrared or near-infrared region. When and where activated, the materials form visible markings having a particular color, darkness, and/or contrast relative to unmarked materials. A coating may enable the generation of markings that are all of a single color, or of multiple colors. The coating may be applied continuously to the surface, or to discrete locations on the surface.

Optical disc 100 includes a central hub 102 which mounts and positions the disc 100 in an optical disc drive for data reading and writing, and for marking a label surface 104 of the disc 100. The label surface 104 typically extends from an inner radius to an outer radius of the disc 100. In some embodiments, the inner and outer radii of the label surface 104 do not extend completely to the inner and outer radii of the disc 100. In one embodiment, a ring of disc control features 106 is disposed closer to the hub 102 than the inner radius. The disc control features 106 are usable by the disc drive to determine and control the speed of rotation of the disc 100, and the angular orientation or angular position of the disc 100 in the disc drive. In one embodiment, the disc control features 106 include an index mark 108 usable to determine a reference position for the angular position of the disc 100 in the drive. For example, angular position 110A may be defined as an angular position of 0 degrees, angular position 110B may be defined an as angular position of approximately 45 degrees, and angular position 110C may be defined an as angular position of approximately 90 degrees. In one embodiment, the disc control features 106 include a plurality of equally-spaced timing features, or “spokes”, 107. While for clarity timing features 107 are illustrated only as disposed between angular positions 110B and 110C, it is understood that timing features 107 are disposed completely around disc 100. In some embodiments, index mark 108 may also serve as a timing feature 107, or a timing feature 107 may be coincident with index mark 108.

A plurality of virtual angular sectors may be defined on the label surface 104. These sectors may be defined in connection with mapping the disk surface contour. A first virtual angular sector 116A is illustrated as spanning angular positions 110A to 110B. Put another way, angular positions 110A-b are the borders of sector 116A. A second virtual angular sector 116B is illustrated as spanning angular positions 110B to 110C. Each virtual angular sector 116 spans the same number of degrees of rotation of the disc 100. Put another way, each virtual angular sector 116 is the same size. These sectors 116 are “virtual” in that they are not physically defined on the disc 100, but rather are defined by the disc drive into which the disc 100 is inserted. In one embodiment, each of the two angular borders 110 of each virtual angular sector 116 is coincident with a timing feature 107, and each virtual angular sector 116 contains an equal number of timing features 107.

The disc drive can define a various number of virtual angular sectors 116 on the disc 100. FIG. 1 illustrates a total of eight virtual angular sectors, in which every third timing feature 107 (of a total of 24 timing features 107) is coincident with a sector border 110. In another embodiment, the disc 100 includes 400 timing features 107, the disc drive defines twenty virtual angular sectors 116 on the disc 100, and every twentieth timing feature 107 is coincident with a border 110 of a sector 116.

The laser beam generated by the optical disc drive can be positioned at a radial position between the inner radius and the outer radius of the label surface 104. While only exemplary radial positions 112A and 112B are illustrated, it is to be understood that a large number of different radial positions 112 may exist on the disc 100.

In one embodiment, locations or positions on the label surface 104 markable by the optical drive are logically organized into virtual concentric or annular rings of individual markable locations or positions 114. Each annular ring, also known as a “virtual track”, has a corresponding radial position 112. While the exemplary markable positions 114 are illustrated in FIG. 1 as circular, it is understood that they may alternatively be oblong, continuous, or have other shapes. An individual markable position 114 can be marked by positioning the laser beam adjacent to the radial position of the desired markable position 114, properly focusing the beam from the laser on the label surface 104 by appropriately positioning the laser focus optics, and synchronizing the application of laser energy to the angular position of the disc 100 during disc rotation. In some embodiments, the concentric rings of markable positions 114 abut one another throughout the label surface 104, and thus the radial position 112 of adjacent annular rings of locations 114 may be generally determined by the dimensions of the locations 114, particularly in the radial direction.

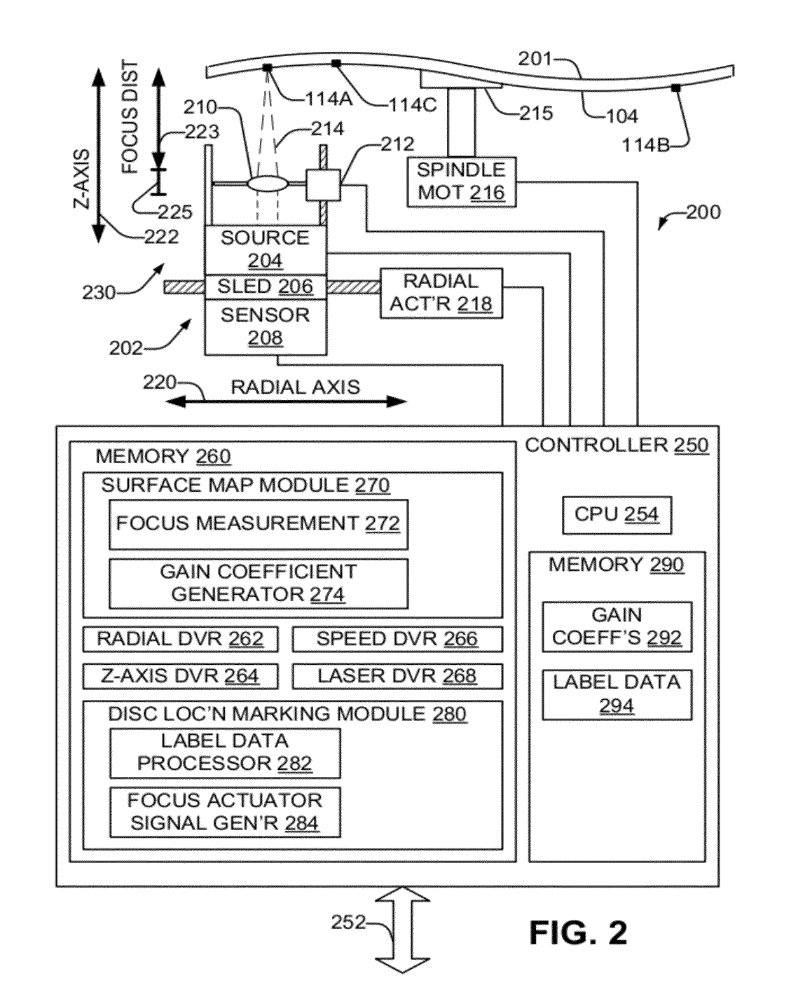

Considering now an embodiment of an optical disc drive usable to label the optical disc 100, and with reference to FIG. 2, an optical disc drive (ODD) 200 includes an optical pick-up unit assembly (OPU) 202. The OPU 202 may include an electromagnetic energy source 204, which may be a laser source, and an objective lens or focus optics 210. The OPU 202 may also include a sled 206, a sensor 208, and a focus actuator 212. The focus actuator 212 is configured to respond to an input signal, which may be voltage or current, to cause the focus optics 210 to move the focal point of the electromagnetic energy beam 214 generated by source 204. The electromagnetic energy beam 214 may be a laser beam. Taken together, the laser source 204 and the focus optics 210 constitute a laser 230.

In an exemplary embodiment, a spindle motor 216 is configured to spin or rotate the optical disc 100 substantially circularly. The optical disc 100 is removably mounted to a spindle 215 by mating the hub 102 of the disc 100 with the spindle 215. When labeling the label surface 104, the disc 100 is mounted such that the label surface 104 faces the laser 230. Where the disc 100 is such that the label surface 104 is on (or is accessed from or through) the opposite side of the disc 100 from a data surface 201 of the disc 100, the disc 100 may be mounted in the drive 200 upside-down from the orientation used when reading digital data from, or writing digital data to, the disc 100.

A radial actuator 218 may be arranged to move the laser 230, which is mounted on the sled 206, to different radial positions along a radial axis 220 with respect to the center of the disc 100. The radial actuator 218 positions the laser adjacent to particular virtual label tracks 112 on the label surface 104 such as, for example, tracks 112A-B. The operation of the spindle motor 216 and radial actuator 218 can be coordinated to move the label surface 104 of the disc 100 and the laser 230 relative to each other to permit the laser 230 to create an image on the disc 100 by forming marks on selected ones of the markable locations 114 on the label surface 104. In some embodiments the radial actuator 218 may include a coarse adjustment mechanism which moves the sled 206 along the radial axis 220, and a fine adjustment mechanism which moves the laser 230 with respect to the sled 206.

In an exemplary embodiment, the focus optics 210 may mounted on lens supports and configured to travel along a z-axis 222 which is generally perpendicular to the label surface 104 of the disc 100. In an exemplary embodiment, the focus actuator 212 adjusts the focal point of the laser beam 214 by moving the focus optics 210 toward or away from the label surface 104 of the disc 100. In an exemplary embodiment, the focus actuator 212 is controlled during a disc marking or labeling operation to place the focus optics 210 at a desired position so that markings of a desired darkness and/or color, and size can be formed on the markable locations 114 of the label surface 104.

Sensor 208 provides signal data indicative of the degree of focus of the laser beam 214 on label surface 104. A portion of the laser energy applied to the label surface 104 can be reflected back through the optics 210 to the sensor 208. In one embodiment, sensor 208 has four individual sensor quadrants, A, B, C and D, that collectively provide a SUM signal. Quadrants A, B, C, and D may be configured to measure reflected light independent of one another. In particular, voltage is generated by the quadrants A, B, C and D in response to reflected light. When the sum of the measured voltage of the quadrants A, B, C and D are at a relative maximum, it is an indication that the focus optics 210 are positioned along the z-axis 222 in a position that places the laser beam 214 at an in-focus position on the label surface 104. In other embodiments, quadrant outputs of sensor 208 may be added or subtracted in other combinations to provide different signals, such as a focus error signal (FES).

In an exemplary embodiment, the disc drive 200 includes a controller 250. The controller 250 may be connected via a computing device interface 252 to a computing device (not shown) or other data source external to the disc drive 200. The controller 250 may be implemented, in some embodiments, using hardware, software, firmware, or a combination of these technologies. Subsystems and modules, or portions thereof, of the controller 250 may be implemented using dedicated hardware, or a combination of dedicated hardware along with a computer or microprocessor controlled by firmware or software. Dedicated hardware may include discrete or integrated analog circuitry and digital circuitry such as programmable logic device and state machines. Firmware or software may define a sequence of logic operations and may be organized as modules, functions, or objects of a computer program. Firmware or software modules may be executed by at least one CPU 254 for processing computer/processor-executable instructions from various components stored in a computer-readable medium, such as memory 260. Memory 260 may be any type of computer-readable medium for use by or in connection with any computer-related system or method. Memory 260 is typically non-volatile, and may be read-only memory (ROM).

In one embodiment, the controller 250 may be implemented on one or more printed circuit boards in the disc drive 200. In other embodiments, at least a portion of the controller 250 may be located external to the disc drive 200. The disc drive 200 may be included in a computer system, such as a personal computer, may be used in a stand-alone audio or video device, may be used as a peripheral component in an audio or video system, or may be used in a stand-alone disc media labeling device or accessory. Other configurations are also contemplated.

In one embodiment, the controller 250 generates control signals for the spindle motor 216, radial actuator 218, focus actuator 212, and electromagnetic energy source 204. The controller 250 also reads data, where appropriate, from these components, including degree-of-focus data from sensor 208.

In some embodiments, the controller 250 includes a radial position driver 262, a z-axis position driver 264, a disc rotation speed driver 266, and a laser driver 268. In an exemplary embodiment, the drivers may be firmware and/or software components which may be stored in memory 260 and executable on CPU 254. The drivers may cause the controller 250 to selectively generate digital or analog control or data signals, and read analog or digital data signals.

In an exemplary embodiment, the disc rotation speed driver 266 drives spindle motor 216 to control a rotational speed of optical disc 100 via the spindle 215. The disc rotation speed driver 266 operates in conjunction with the radial position driver 262 which drives the radial actuator 216 to control at least coarse radial positioning of OPU assembly 202 with respect to disc 100. In disc surface contour mapping operations, and disc location marking operations, the sled 206 of OPU 202, including laser 230, is moved along the radial axis 220 to various virtual tracks 112 of optical disc 100. In some embodiments, for a given radial position of the laser 230 the disc rotation speed driver 266 rotates the disc 100, for a given virtual track 112, at a faster speed during disc surface contour mapping operations than during disc location marking operations.

In an exemplary embodiment, the laser driver 268 controls the various components of the OPU 202. The laser driver 268 controls turning the laser source 204 on and off, and controls the intensity of the laser beam 214 generated by the laser source 204. In some embodiments, a lower intensity laser beam 214 is generated during disc surface contour mapping operations, while a higher intensity laser beam 214 is generated during disc location marking operations.

In an exemplary embodiment, the z-axis position driver 264 controls the focus actuator 212 in order to adjust the position of the focus optics 210 along the z-axis 222.

In an exemplary embodiment, the controller 250 further includes a disc surface contour mapping module 270, and a disc location marking module 280. The disc surface contour mapping module 270 maps the contour of the label surface 104 of the disc 100 by determining the position of the laser optics 210 that focuses the laser beam 214 to a desired degree of focus on the virtual angular sectors 116 of a desired virtual track 112 on the label surface 104 of the disc 100. To prevent the markings from exhibiting undesirable darkness or color variations due to differences in the laser energy absorbed at locations 114 in different virtual angular sectors 116 on the label surface 104 due to differences in surface contour between the sectors, the focus is generally maintained within a few microns of the label surface 104 for all sectors 116 in which locations 114 are marked.

The disc surface contour mapping may be performed, prior to labeling the label surface 104, for any of a variety of reasons. For example, while a conventional disc drive is capable of maintaining the laser in an in-focus position in real-time during reading data from, or writing data to, the data surface 201 of the disc 100 regardless of any tilt or warp in the disc 100, it cannot do so when forming a visible label to the virtual tracks 112 of label surface 104. One reason is that the quality of the signal detected by the sensor 208 is inadequate. This occurs where the label surface 104 is not as reflective as the data surface 201. In such a situation, it is difficult or impossible to extract a reliable signal from the sensor 208 in real-time. In addition, the label surface 104 is typically not as smooth as the data surface 201. As a result, the signal from the sensor 208 may need to be averaged to eliminate the noise, which prevents real-time focusing during marking. Another reason why disc surface contour mapping is performed is that the desired degree of focus for a marking operation does not correspond to an in-focus position of the laser, but rather to a defocused position of the laser. This defocusing may be accomplished, in one embodiment, by applying a focus offset signal to the focus actuator 212 that offsets the optics 210 a focus offset distance 225 along the z-axis 222 from its actual in-focus distance 223. One reason for defocusing the laser is to produce a larger spot size, and thus a larger mark, than would be produced with an in-focus laser beam. However, when the laser is defocused to the desired degree for marking, the sensor 208 will typically be operating outside of its usable signal range for providing real-time focus control.

Thus because of at least these factors, the disc surface contour is mapped before the laser forms the marks. However, because disc contour mapping is an additional, sequential operation, it increases the total time to label the disc.

With regard to the contour of the label surface 104, disc 100 is exemplarily illustrated in FIG. 2 not as being flat, but as having a surface contour that varies with radial and angular position on the disc 100 (the contour variation is exaggerated for clarity of illustration). The laser beam 214 is illustrated as focused at location 114A on label surface 104. Location 114A corresponds to a certain virtual track 112 and angular position 110, and focus actuator 212 places laser optics 210 in the position illustrated so that the laser beam 214 is focused at location 114A. However, when disc 100 is rotated so that location 114B, located on the same virtual track 112 as location 114A but in a different angular position 110, is positioned adjacent the laser 230, the controller 250 instructs the focus actuator 212 to move optics 210 to a different position along the z-axis 222 in order to make the laser beam focus at location 1148. This is due to the variation in the surface contour of the disc 100 which causes location 114B to be, for example, closer to the laser source 204 along z-axis 222 than is location 114A.

Similarly, consider location 114C on label surface 104, which may be located at the same angular position 110 as location 114A, but on a different virtual track 112. When the laser source 204 is moved along the radial axis 220 so that the laser beam 214 impinges location 114C instead of 114A, focus actuator 212 moves the optics 210 to a different position along the z-axis 222 in order to make the laser beam focus at location 114C. This is due to the variation in the surface contour of the disc 100 in the radial direction, which causes location 114C to be, for example, farther from the laser source 204 along z-axis 222 than is location 114A.

In some embodiments, the disc surface contour mapping module 270 determines gain coefficients 292 of an algorithm that can subsequently be used by a disc location marking module 280 to control the focus actuator 212 to move the focus optics 210 to the proper z-axis position for the corresponding angular position 110 to form marks having consistent image quality when labeling desired markable locations 114 on the disc 100. In one embodiment, the algorithm is a Fourier series. The gain coefficients and Fourier series can generate signals for the focus actuator 212, synchronized with the rotation of the disc 100, that position the focus optics 210 so that the laser beam 214 is focused on the label surface 104 for all angular positions 110 as the disc 100 rotates, regardless of any tilt or warp in the disc 100.

In some embodiments, the disc surface contour mapping module 270 includes a focus measurement module 272. As will be discussed subsequently in greater detail, the focus measurement module 272 sweeps the focus optics 210 sinusoidally from a baseline position, applies the laser beam 214 to the disc 100 through the focus optics 210, and measures SUM signals from the sensor 208 that are indicative of the degree of focus of the laser beam 214 on the label surface 104. A SUM signal measurement is made at multiple locations 114A within each virtual angular sector 116 of the disc 100 as the focus optics are sinusoidally swept through that sector 116. For a given radial position 112, the focus optics sweep, laser beam application, and signal measurements are performed for all sectors 116 of the disc 100 during a single revolution of the disc 100.

In some embodiments, the disc surface contour mapping module 270 includes a gain coefficient generator module 274. As will be discussed subsequently in greater detail, the gain coefficient generator module 274, for each virtual angular sector 116, calculates an error term from the measured SUM signals for that sector 116, and recalculates (i.e. updates or modifies) the gain coefficients 292 for that sector based on the calculated error term. All of the SUM signal measurements needed for the gain coefficient generator module 274 to calculate the error term and recalculate the gain coefficients 292 for all of the virtual angular sectors 116 of the disc 100 are measured in the single rotation of the disc performed by the focus measurement module 272. If a calculated error term has not yet converged to a desired value indicative of a sufficiently accurate mapping of the disc surface, the disc surface contour mapping module 270 will repeat (i.e. iterate) the operations of the focus measurement module 272 and gain coefficient generator module 274, until the error terms converge and a sufficiently accurate mapping is achieved. At least the final version of the gain coefficients 292 are stored in memory 290.

The operation of the disc surface contour mapping module 270 has been described above with reference to a particular virtual track or radial position 112. The operation is typically repeated for each of a number of different radial positions 112, for each of which a separate set of gain coefficients 292 is determined, since the surface contour of the disk 100 can vary with radial position 112 as well as angular position 110, as explained heretofore. During operation in some embodiments, the disc surface contour mapping module 270 rotates the disc 100 at a faster speed for a given radial position 112 than does the disc location marking module 280.

The disc location marking module 280 marks designated ones of the markable locations 114 on the disc 100, according to label data 294 indicative of the labeling image to be formed on the disc 100. The label data 294 may be received via computing device interface 252 from a source external to disc drive 200, such as from a personal computer. In some embodiments, the disc location marking module 280 includes a label data processor module 282 that processes the image data 294 to determine the radial position 112 and angular position 110 on the disc 100 of ones of the markable locations 114 designated by the data 294 to be marked by the laser beam 214. In some embodiments, the label data processor module 282 may also determine, for the designated locations 114 to be marked, the darkness, contrast, and/or color of the mark. In some embodiments, as will be discussed subsequently in greater detail, the disc location marking module 280 includes a focus actuator signal generator module 284 that calculates, using the gain coefficients 292, a signal for the focus actuator 212 that positions the focus optics 210 at the desired focus position to form the desired mark at the radial position 112 and the angular position 110 of each location 114 to be marked. As the sled 206 is positioned at a designated radial position 112, and as the disc 100 is being rotated by the spindle motor 216, the disc location marking module 280 applies to the focus actuator 212 the calculated focus position signal in sync with the rotation of the disc 100, so that the laser 230 can form the desired mark on the location 114 as it passes adjacent the laser beam 214. In some embodiments, the disc location marking module 280 rotates the disc 100 at a slower speed for a given radial position 112 than does the disc surface contour mapping module 270.

In one embodiment, the gain coefficients 292 and the label data 294 are stored in a read-write (RAM) memory 290. In some embodiments, memory 260 and memory 290 may be the same memory device. In some embodiments, the gain coefficients 292 and the image data 294 may be stored in different memory devices.

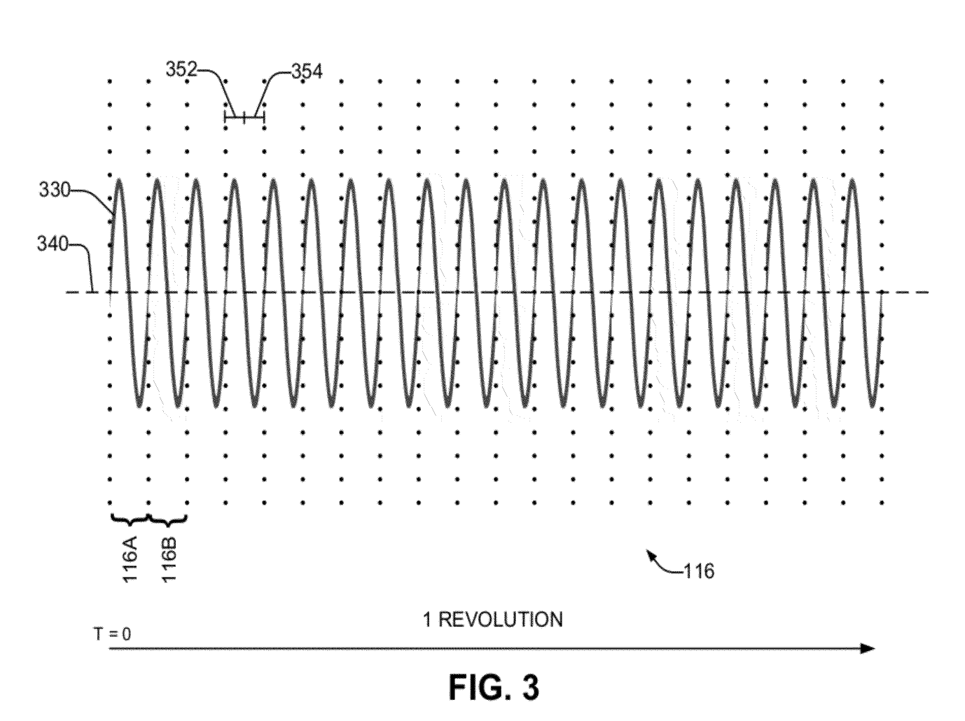

Considering now in greater detail, with reference to FIG. 3, the operation of one embodiment of the focus measurement module 272 of the surface contour mapping module 270, the focus measurement module 272 sweeps the focus optics 210 in a substantially sinusoidal displacement or motion 330 from a baseline position 340 once per virtual sector 116. The focus optics 210 are swept by the application of a substantially sinusoidal voltage or current signal to the focus actuator 212.

The location of the baseline 340 (i.e. the z-axis location 222 of the focus optics 210 above the label surface 104) is such that the sensor 208 can generate a usable SUM signal. In some embodiments, a nominal baseline 340 may be established as part of an initial disc detect operation (not shown) performed by the drive 200 when the disc 100 is inserted thereto. While baseline 340 is illustrated in FIG. 3 as a constant position throughout all sectors 116 of the disc 100, this typically represents the operating condition of only a first iterative execution of the focus measurement module 272 for a given radial position 112. In subsequent iterative executions of the module 272 at that given radial position 112, the baseline 340 may neither be constant nor linear; it may be established, as will be discussed subsequently with reference to the gain coefficient generator 274, by using gain coefficients 292 that have been previously determined by the gain coefficient generator 274. The sinusoidal sweep motion 330 may be considered as being superimposed on the baseline 340 in some embodiments.

In the exemplary operation of FIG. 3, the disc 100 is divided into twenty virtual angular sectors 116, and thus the focus optics are swept sinusoidally for twenty cycles during a single revolution of the disc 100. While traversing the first half 352 of each sector 116, the focus optics 210 are swept further from the label surface 104 of the disc 100 than the baseline 340. While traversing the second half 354 of each sector 116, the focus optics 210 are swept closer to the label surface 104 of the disc 100 than the baseline 340. In an alternate embodiment, the focus optics 210 may be swept closer during the first half, and further during the second half, of the traversal of each sector 116. Sector boundaries, such as at angular positions 110A-c, correspond to the zero-crossing point between individual cycles of the sinusoidal motion 330, where the focus optics 210 are positioned at the baseline 340.

During the rotation, and while the focus optics 210 are being sinusoidally swept, the laser 230 is energized and the laser beam 214 applied to disc 100, and the SUM signal from sensor 208 is measured at a plurality of angular positions 110 within each sector 116. In one embodiment, the SUM signal measurements are taken in synchronization with the periodic application of laser beam 214. A portion of the applied laser beam 214 is reflected from the label surface 104 to the sensor 208 to generate the SUM signals. In one embodiment, the angular positions 110 at which the SUM signal is measured corresponds to the position of timing features 107. Thus, in an embodiment having 20 sectors 116 on disc 100 and 400 total timing features 107, the SUM signal is measured 20 times for each sector 116.

At the completion of a single revolution of the disc 100, for each sector 116, a plurality of SUM signal measurements corresponding to the sinusoidal displacement of the focus optics 210 that is substantially symmetrical about baseline 340 have been collected. From these measurements, as will be discussed subsequently with reference to the gain coefficient generator 274, an error term descriptive of the degree of focus of the laser beam 214 on the label surface 104 can be calculated.

In one embodiment employing the sinusoidal motion 330, twenty virtual angular sectors 116 are defined on the disc 100, and the gain coefficient generator 274 derives nine gain coefficients for a Fourier series having a DC component and first-order through fourth-order sinusoidal and cosinusoidal components. In one embodiment, for a given virtual track 112, the focus measurement module 272 rotates the disc 100 at a faster speed (i.e. a higher rpm) than the speed at which the disc 100 is rotated by the disk location marking module 280. In one embodiment, the focus measurement module 272 rotates the disc 100 at greater than 50 rpm.

Other focus measurement techniques displace the focus optics 210 in a different manner. For example, one technique displaces the optics 210 in a substantially linear ramp in one direction relative to the label surface 104 (for example, toward the surface) in the first half of the sector, and applies the baseline signal in the second half of the sector to return the focus optics 210 to the baseline. However, in order to obtain a plurality of SUM signal measurements that represent a displacement of the focus optics 210 that is substantially symmetrical about the baseline, during a second revolution of the disc 100, the optics 210 are displaced in a substantially linear ramp in the opposite direction (for example, away from the label surface 104) in the first half of the sector, and the baseline signal applied in the second half of the sector to return the focus optics 210 to the baseline during a second revolution of the disc 100. Thus, in order to collect a sufficient set of measurements to calculate the error term, two revolutions of the disc 100 are performed, instead of one. Performing this sequence multiple times when iterating at a single radial position 112, and then doing so at a number of different radial positions 112 in order to map the entire disc 100, approximately doubles the total amount of time required to perform the disc surface contour mapping operation. The same occurs in another focus measurement technique where a half-sine wave is utilized instead of a ramp. Accordingly, using a sinusoidal displacement 330 in the focus measurement module 272, such that all the SUM signal measurements for all the sectors 116 are performed in a single revolution of the disc 100, advantageously reduces the time required to perform the disc surface contour mapping operation, compared to focus measurement techniques requiring two revolutions, for a given disc rotation speed.

Sinusoidal displacement 330 applied to an electromechanical system such as the focus optics 210 also provides other benefits relative to these other focus measurement techniques. Due to the mass of the focus optics 210 and associated movable components of the drive 200, significant overshoot and ringing in the motion of these components can occur when the signal applied to the focus actuator 212 includes high frequency content, such as may occur from an abrupt change in slew rate of the motion of these components. For example, the point at which a ramp signal abruptly changes from its peak value to the baseline value at the midpoint of a sector 116 is a discontinuity that includes high frequency content. Another is the abrupt termination of a half-sine wave when it reaches the baseline value midway through the sector 116. One adverse effect of such overshoot and ringing is the introduction of noise into the SUM signal measurements, which in turn lowers the signal-to-noise ratio and introduces error into the gain coefficient generation. The error can increase the number of iterations (and thus increase the time) required to obtain optimal gain coefficients 292, or may yield erroneous gain coefficients 292 which cause reduced image quality in the label marks formed on the label surface 104 by the disc location marking module 280.

Because the sinusoidal motion 330 is continuous, it minimizes overshoot and ringing, and has lower harmonic content. Furthermore, the sinusoidal motion 330 permits a greater number of virtual angular sectors 116 to be defined on the disc 100 than do discontinuous displacement approaches. To compensate for the overshoot and ringing caused by non-sinusoidal motion, the focus optics 210 and associated components may be moved more slowly, or more settling time provided, to help minimize noise from overshoot and ringing in the measured SUM signal. However, doing so means defining a fewer number of virtual angular sectors 116 on the disc 100, and/or rotating the disc 100 at a relatively slower speed during the focus measurement operation. Both can be disadvantageous. Rotating the disc 100 more slowly directly adds to the disc surface contour mapping time required. Measuring SUM signals for a fewer number of sectors 116 can be insufficient to accurately model the surface contour, particularly the higher-frequency surface effects often exhibited by multi-layer discs 100. For example, defining and measuring 8 sectors may not be sufficient to model third-order and fourth-order sinusoidal effects. If these effects are not accounted for during modeling, the focus optics 210 cannot subsequently be positioned to account for them during labeling, which can result in focus errors that decrease the image quality of the label marks formed on these discs 100.

One characteristic of the two-revolution approaches is that the same portion of the disc surface (i.e. the same half-sector) is measured for both directions of the displacement (i.e. both toward and away from the disc). In the sinusoidal motion 330, two adjacent half-sectors are measured in one revolution. For a given number of virtual angular sectors 116 each having a given angular span, spatial error may be introduced with the one-revolution approach due to variation in the surface contour between the first and second half-sectors. Such spatial error does not occur with the two-revolution approaches that measure the same half-sector for both directions of the displacement. However, the ability provided by the one-revolution, sinusoidal motion 330 approach to significantly increase the number of virtual angular sectors 116 defined on the disc 100, as described above, can reduce or eliminate such spatial error. For example, consider a two-revolution approach that defines 8 virtual sectors. Each sector spans 45 degrees, thus the focus measurement is performed in a half-sector that spans 22.5 degrees. Now consider a one-revolution approach that defines 20 virtual sectors 116 on the disc 100. Each sector spans 18 degrees. Therefore, even though both half-sectors 352,354 are measured, together they comprise a smaller angular span than the two-revolution approach. The SUM error value is averaged across the sector so if the sector is sufficiently small the effective spatial error is negligible.

Before considering the gain coefficient generator 274 of the surface contour mapping module 270, it is useful to consider the generation of the baseline signal 340 for the focus actuator 212. In one embodiment, a Fourier series uses gain coefficients and the angle of rotation of the disc 100 to generate the baseline signal 340, according to the following algorithm:

Baseline signal=(A0*DC0)+(A1*QS1)+(B1*QC1)+(A2*QS2)+(B2*QC2)+(A3*QS3)+(B3*QC3)+(A4*QS4)+(B4*QC4).

The DC0 term is a DC component of the signal. The QSn and QCn terms are sinusoidal and cosinusoidal terms respectively. The value of n indicates the order of the term; for example, QS1 is a first-order sine term, while QC4 is a fourth-order cosine term, corresponding to the first and fourth harmonic respectively. The order corresponds to a multiplier for the angle of rotation. For example, for a given angle of rotation, theta, the value of QS1=sin(theta), while the value of QC4=cos(4*theta).

A0 through A4, and B1 through B4 are the nine gain coefficients for the corresponding nine terms of the Fourier series. On the first iteration performed by the disc surface contour map module 270, the value of A0 is selected to set to a nominal value such that the sensor 208 can generate a usable SUM signal during the focus measurement 272 operation, while the values of A1 through A4 and B1 through B4 are set to zero. This will generate the constant linear baseline signal 340 as illustrated in FIG. 3, corresponding to a flat surface 104 of the disc 100, on which the sinusoidal motion 330 is superimposed. In subsequent iterations of the disc surface contour map module 270 that use the gain coefficients 292 generated by the previous operation of the gain coefficient generator 274, the baseline signal 340 will typically neither be constant nor linear, and the sinusoidal motion 330 will be superimposed upon that baseline 340.

Considering now in greater detail the operation of one embodiment of the gain coefficient generator 274 of the surface contour mapping module 270, the gain coefficient generator 274 uses the SUM signal measurements to calculate, for each sector 116, an error term descriptive of the degree of focus of the laser beam 214 on the label surface 104 of that sector 116, and uses the error signal, along with gain coefficients 292 from a previously iteration of the generator 274, to generate updated or modified gain coefficients 292. The updated or modified gain coefficients 292, when used in the next iteration of the focus measurement 272 operation, are intended to improve the degree of focus on the sectors 116. When the disc surface contour map module 270 completes its cycle of iterating the focus measurement 272 and gain coefficient generator 274 operations, the finalized gain coefficients 292 provide a high degree of focus of the laser beam 214 on the label surface 104 for all sectors 116.

In one embodiment, the SUM signal measurements for one half-sector 352 represent sweeping the focus optics 210 further from the label surface 104 of the disc 100 than the baseline 340, and the SUM signal measurements for the other half-sector 354 represent sweeping the focus optics 210 closer to the label surface 104 of the disc 100 than the baseline 340. The error term for the sector 116 comprised of the two half-sectors 352,354 is generated by adding the SUM signal measurements for the one half-sector 352 and the other half-sector 354, and then by taking the difference between these two totals. For example, assume that the SUM signal measurement is normalized such that the measured SUM signal has a value between 0 and 1. Further, assume that 10 SUM signal measurements are made during each half-sector 352,354, and that the total of the SUM signal measurements for the first half-sector 352 of sector 116 is 7, and the total of the SUM signal measurements for the second half-sector 354 of sector 116 is 3. Subtracting the total for the second half-sector 354 from the total for the first half-sector 352 results in an error term of +4 for the sector 116. It can be observed that, because half the SUM signal measurements are made with the focus displaced from the baseline 340 in one direction and the other half in the other direction, the above sum-and-difference operation effectively integrates the error over a sector 116. It can also be observed that, when a larger number of sectors 116 are defined on the label surface 104 of the disc 100, fewer measurements are integrated for a given sector 116 and more error terms are generated, allowing a higher accuracy surface model capable of confirming to higher-order surface deviations to be constructed.

Next, the gain coefficients 292 for the sector are updated using the error term, in one embodiment according to the following formulas:

A0(updated)=A0(prior)+(DC0*Ek*Mu)

A1(updated)=A1(prior)+(QS1*Ek*Mu)

B1(updated)=B1(prior)+(QC1*Ek*Mu)

A2(updated)=A2(prior)+(QS2*Ek*Mu)

B2(updated)=B2(prior)+(QC2*Ek*Mu)

A3(updated)=A3(prior)+(QS3*Ek*Mu)

B3(updated)=B3(prior)+(QC3*Ek*Mu)

A4(updated)=A4(prior)+(QS4*Ek*Mu)

B4(updated)=B4(prior)+(QC4*Ek*Mu)

The DC0 term, the QSn and QCn terms, and the gain coefficients A0 through A4 and B1 through B4 are as defined heretofore. The prior gain coefficients are those used when making the SUM signal measurements used to derive the error term, Ek. Mu is a coefficient that weights the effect of the error terms as they are used to modify the updated coefficients. If the error term were allowed to overly influence a present value of the focus actuator signal, the focus optics 210 might swing too wildly, resulting in excessive iterations of the focus measurement 272 and gain coefficient generation 274 operations, or might not allow the surface model to converge to a stable set of gain coefficients 292. Conversely, if the error term is overly suppressed from influencing the focus actuator signal, the focus optics 210 might not respond quickly enough to changing conditions, thus also resulting in excessive iterations of the focus measurement 272 and gain coefficient generation 274 operations. Accordingly, the value of Mu input 208 should be selected according to the specific characteristics of the drive 200 and other factors, in order to allow the surface model to converge to a stable set of gain coefficients 292 in an optimal time. In one embodiment, the gain coefficients 292 are determined to have converged if the error term is below a threshold. In another embodiment, the gain coefficients 292 are determined to have converged if the change in gain coefficients between iterations is below a threshold.

It is noted that the above operation of the gain coefficient generator 274 was described for one sector 116. The gain coefficient generator operation is repeated, in some embodiments, for all of the sectors 116 that are defined on the label surface 104 of the disc 100, generating a set of gain coefficients 292 for each sector 116. In some embodiments, the values of the individual gain coefficients 292 for the sectors 116 are averaged in order to derive overall gain coefficients 292 usable to generate the baseline signal 340 for the next iteration.

For example, for a disc 100 having 20 sectors 116, the value of the 20 individual B1(updated) gain coefficients is averaged to derive an overall B1(updated) gain coefficient.

Considering now in greater detail the operation of the focus actuator signal generator module 284, in one embodiment the overall gain coefficients resulting from the final iteration are also used in the operation of the signal generator module 284 during a disk location marking 280 operation. Similar to the generation of the baseline signal 340 during the operation of the disc surface mapping module 270, a Fourier series uses gain coefficients and the angle of rotation of the disc 100 to generate the control signal for the focus actuator 212 that accurately positions the focus optics 210, in synchronization with the rotation of the disc, at the proper distance from the label surface 104 to produce marks of high image quality, according to the following algorithm:

Actuator signal=(A0*DC0)+(A1*QS1)+(B1*QC1)+(A2*QS2)+(B2*QC2)+(A3*QS3)+(B3*QC3)+(A4*QS4)+(B4*QC4).

The various terms are the same as have been described heretofore. It is noted that no sinusoidal signal is superimposed thereon during the disk location marking 280 operation although, in some embodiments, a constant focus offset value may be added as described previously.

In some embodiments, the disc surface mapping 270 operation is performed for the entire disc 100 before the disc location marking 280 operation is performed for any of the positions 114 on the disc 100. In some embodiments, the disc 100 is rotated at a slower rotational speed during the operation of the disc location marking module 280 than during the operation of the disc surface mapping module 270. This may occur where characteristics of the laser 230 and label surface 104 are such that a slower rotation during marking is used to ensure that a sufficient amount of laser energy be delivered to the positions 114 being marked to form marks of the proper color or darkness. Due to the inertia of the focus actuator 212, focus optics 210, and related components, the mechanical response to a signal to the focus actuator 212 is not instantaneous, and thus while the disc 100 is rotating, the response of the focus actuator 212 to a signal applied at a given angular position 110 will not mechanically occur until the disc 100 has already rotated to a different angular position 110. This effect may be represented as an angular phase shift equal to the difference between the angular position 110 when a signal is applied, and the angular position 110 when the focus actuator 212 mechanically completes its movement. The drive controller 250 may compensate for this phase shift by applying actuator signals earlier in the rotation such that when the mechanical response of the focus actuator 212 does occur, it occurs at the desired angular position 110. Since the actuator response time remains constant, the magnitude of angular phase shift will depend on the speed of rotation of the disc 100. At a slower rotational speed the phase shift angle will be smaller, while at a higher rotational speed the phase shift angle will be greater. During the operation of the disc location marking module 280, this phase shift is compensated for by applying a phase offset between the mapping 270 and marking 280, to ensure that the focus optics 210 are properly positioned for positions 114. In one embodiment, the phase offset may be derived from the ratio of the two speeds of rotation used for mapping 270 and marking 280.

In one embodiment, the disc location marking module 280 rotates the disc 100, for a given radial position 112, at a slower speed than the disc surface mapping module 270. In one embodiment, the disc location marking module 280 rotates the disc 100 at less than 6 rpm during the marking operation.

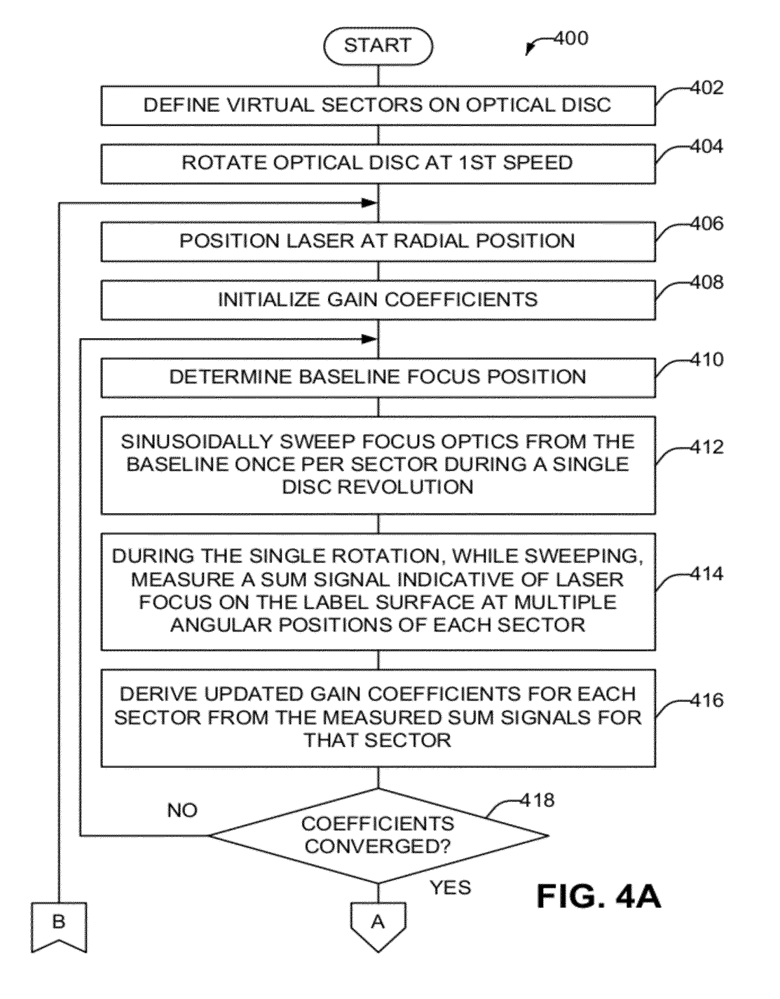

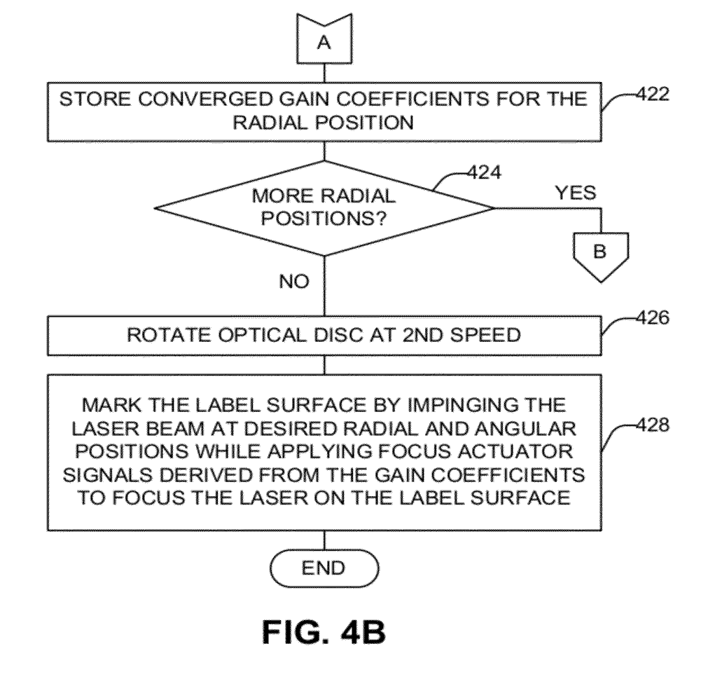

Considering now in greater detail one embodiment of a method of forming a visible label on an optical disc, and with reference to FIGS. 4A-4B, the method 400 can be considered as having a mapping phase that encompasses steps 404 through 424 and a marking phase that encompasses steps 426 through 428. In some embodiments, the method may be implemented in the disc drive 200 and performed by controller 250, where some or all of the steps are stored as instructions in memory, such as memory 260, and are computer-executable by CPU 254. Disc surface mapping module 270 may perform the mapping phase, while disc location marking module 280 may perform the marking phase.

At 402, a plurality of virtual angular sectors 116 are defined on a label surface 104 of an optical disc 100. In some embodiments at least 16 sectors are defined. In another embodiment, 20 sectors are defined.

At 404, the optical disc is rotated at a first speed. In some embodiments, the first speed is greater than 50 rpm. In some embodiments, for a given radial position 112, the first speed is faster than a second speed at which the disc is rotated during the marking phase.

At 406, the laser 230, and consequently the laser beam 214, is positioned at a radial position 112 at which the contour of the label surface 104 is to be characterized.

At 408, initial values of the current overall gain coefficients are established. The overall gain coefficients are used to generate the signal to the focus actuator 212 to position the focus optics 210 at the baseline 340 during the mapping phase, and to generate the signal to the focus actuator 212 to position the focus optics 210 at the desired focus position when marking disc locations 114 during the marking phase. In some embodiments, the initial gain coefficient for the DC term equals 1, and the initial gain coefficients for the sinusoidal and cosinusoidal terms equals 0.

At 410, a baseline focus position for focus optics 210 of the laser 230 for the sectors 116 is determined. In some embodiments, a signal for the focus actuator 212 is derived to set the baseline 340 by using the current overall gain coefficients 292 in an algorithm. In some embodiments, the algorithm is a Fourier series algorithm.

At 412, the focus optics 210 of the laser 230 are sinusoidally swept from the baseline 340 once per sector 116 during a single revolution of the disc 100. In some embodiments, a sinusoidal signal 330 is superimposed on the actuator signal for the baseline 340. The signal applied to the focus actuator 212 is a continuous sinusoid 330 during the single revolution of the disc 100.

At 414, while sweeping the focus optics 210 during the single rotation of the disc 100, the laser beam 214 from the laser 230 is impinged on the label surface 104, and a SUM signal indicative of a degree of focus of the impinged laser beam 214 on the label surface 104 is measured at multiple angular positions 110 of each sector 116. In some embodiments, the laser beam 214 is periodically impinged on the label surface 104 at a time, and for a duration, that allows the SUM signal to be measured at the particular multiple angular positions 110 of each sector 116. In some embodiments, each of the multiple angular positions 110 corresponds to one of the timing features 107, which may be on the disc 100 or alternatively in the drive 200. All of the SUM signal measurements needed to modify the gain coefficients 292 for one iteration of the mapping phase are measured during a single rotation of the disc 100.

The disc drive 200 typically continues to rotate the disc 100 at the first speed throughout the mapping phase, in order to minimize or eliminate start-up and settling times associated with starting and stopping disc rotation. However, the operation of steps 412 and 414 are performed during a single revolution of the disc 100.

At 416, updated gain coefficients for each sector 116 are derived from the measured SUM signals for that sector 116. In some embodiments, an error term is generated from the measured SUM signals for each sector 116, and updated gain coefficients for that sector 116 are derived from the error term for that sector 116. Typically, the updated gain coefficients for the individual sectors 116 are averaged over all sectors 116 to derive updated overall gain coefficients 292.

At 418, it is determined whether or not the overall gain coefficients have converged. In some embodiments, convergence is determined if the error terms are below a threshold. In some embodiments, convergence is determined if the change in overall gain coefficients between iterations is below a threshold. If the gain coefficients have not converged (“No” branch of 418), the mapping phase loops back to 410 and the new baseline focus position is determined using the updated gain coefficients.

If the gain coefficients have converged (“Yes” branch of 418), then at 422 the converged overall gain coefficients 292 for the radial position 112 are stored, such as, for example, in memory 290.

At 424, it is determined whether the label surface 104 of the disc 100 is to be characterized at another radial position 112. Typically, the disc 100 includes a large number of virtual radial tracks 112 between the inner and outer radii of the disc 100. However, in some embodiments the overall gain coefficients 292 determined for one radial position 112 will also be used for a number of adjacent radial positions. In some embodiments, the overall gain coefficients 292 are only determined at or near radial positions 112 of locations 114 at which the label data 294 indicates marks will be made. If the label surface 104 of the disc 100 is to be characterized at another radial position 112 (“Yes” branch of 424), the mapping phase continues at 406 by positioning the laser 230 at the next radial position 112 to be characterized.

If the characterization of all radial positions 112 has been completed (“No” branch of 424), the method enters the marking phase. At 426, the disc 100 is rotated at a second speed. In some embodiments, the second speed is less than 6 rpm. In some embodiments, the second speed is slower than a first speed at which the disc 100 is rotated during the mapping phase.

At 428, selected locations 114 on the label surface 104 are marked by controlling the laser 230 to impinge the laser beam 214 at the desired radial 112 and angular 110 positions on the label surface 104 that correspond to the locations 114, while applying signals to the focus actuator 212 which position the focus optics 210 to focus the laser beam 214 on the locations 114 on the label surface 104. In some embodiments, the signals for the focus actuator 212 are derived by using the overall gain coefficients 292 for the radial position 112 of the location(s) 114 in an algorithm to generate the signals. In some embodiments, the algorithm is a Fourier series algorithm. In some embodiments, the Fourier series comprises a DC component and first-order through fourth-order sinusoidal and cosinusoidal components, where one of the overall gain coefficients 292 for the radial position 112 is associated with each of the components. In some embodiments, a constant focus offset is added to the signal generated by the algorithm.

From the foregoing it will be appreciated that the disc drive and methods provided by the present invention represent a significant advance in the art. Although several specific embodiments of the invention have been described and illustrated, the invention is not limited to the specific methods, forms, or arrangements of parts so described and illustrated. For example, the invention is not limited to an optical disc drive. Rather, the invention also applies to other devices which mark optically-labelable material having a varying surface contour, regardless whether the motion between the labelable material and the source of electromagnetic energy is rotational or translational. This description of the invention should be understood to include all novel and non-obvious combinations of elements described herein, and claims may be presented in this or a later application to any novel and non-obvious combination of these elements. The foregoing embodiments are illustrative, and no single feature or element is essential to all possible combinations that may be claimed in this or a later application. Unless otherwise specified, steps of a method claim need not be performed in the order specified. The invention is not limited to the above-described implementations, but instead is defined by the appended claims in light of their full scope of equivalents. Where the claims recite “a” or “a first” element of the equivalent thereof, such claims should be understood to include incorporation of one or more such elements, neither requiring nor excluding two or more such elements. Terms of orientation and relative position (such as “top”, “bottom”, “side”, and the like) are not intended to require a particular orientation of embodiments of the present invention, or of any element or assembly of embodiments of the present invention, and are used only for convenience of illustration and description.

What is claimed is:

1. A method for determining actuator signals for focusing a laser on a label surface of an optical disc, comprising:
defining a plurality of virtual angular sectors on the label surface;
performing a single rotation of the disc;
during the rotation, sinusoidally sweeping the focus of the laser from a baseline once per sector;
during the rotation, measuring a SUM signal indicative of a degree of focus of the laser on the label surface at a plurality of angular positions of each sector;
deriving the actuator signals, at least in part, from the measured SUM signals.

2. The method according to claim 1, wherein sinusoidally changing the focus sets the focus further from the disc than the baseline in a first portion of each sector, and closer to the disc than the baseline in a second portion of each sector.

3. The method according to claim 1, further comprising:
marking the label surface with the laser while applying the derived actuator signals to focus the laser.

4. The method according to claim 1, wherein the plurality of virtual angular sectors comprises at least 16 sectors.

5. The method according to claim 1, wherein, for a given radial position, the disc is rotated at a faster speed while sinusoidally sweeping the focus of the laser and measuring a SUM signal than while marking the label surface.

6. The method according to claim 1, wherein the performing, sweeping, measuring, and deriving are performed for a particular radial position of the disc, and wherein the performing, sweeping, measuring, and deriving are repeated at a plurality of different radial positions of the disc.

7. The method according to claim 1, wherein deriving the actuator signals comprises determining gain coefficients for a Fourier series that generates the actuator signals for the plurality of angular positions of each track.

8. The method according to claim 7, wherein deriving the actuator signals comprises repeating the performing, sweeping, and measuring until the determined gain coefficients converge.

9. The method according to claim 7, wherein the Fourier series comprises a DC component, first-order through fourth-order sinusoidal and cosinusoidal components, and a gain coefficient associated with each of the components.

10. An optical disc drive for marking a label surface of an optical disc, comprising:
a laser configured to controllably emit a beam;
focus optics movable to focus the beam onto the label surface; and
a controller configured to
rotate the disc through a single revolution,
sweep the focus optics sinusoidally from a baseline position once per angular sector of the disc during the revolution,
measure a SUM signal indicative of a degree of focus of the beam on the label surface at multiple positions of each sector during the revolution, and
using the measured SUM signals, derive actuator signals that move the focus optics to focus the beam onto the label surface.

11. The optical disc drive according to claim 10, wherein each angular sector corresponds to a same number of equally-spaced timing features detectable by the drive, and wherein each of the multiple positions corresponds to one of the timing features.

12. The optical disc drive according to claim 10, wherein the SUM signal represents a summation of values from a plurality of focus sensors and is different from a focus error signal (FES).

13. A computer-readable medium having processor-executable instructions thereon which, when executed by a processor, cause the processor to:
define a plurality of virtual angular sectors on a label surface of an optical disc disposed in a disc drive;
control a motor of the drive to rotate the disc through a single revolution;
while rotating, sweep focus optics of a laser sinusoidally from a baseline position once per angular sector;
while sweeping, measure a SUM signal indicative of a degree of focus of the laser on the label surface at multiple positions of each sector; and
using the measured SUM signals, determine gain coefficients usable to generate signals for the focus actuator that positions the focus optics so as to focus the laser on the label surface.

14. The medium according to claim 13, wherein the plurality of virtual sectors comprises at least 16 sectors and wherein the disc is rotated at greater than 50 rpm.

15. The medium according to claim 13, wherein the gain coefficients are determined iteratively, and wherein all of the SUM signal measurements needed to determine the gain coefficients for one iteration are measured in the single rotation of the disc.
